(19) United States
(12) Patent Application Publication
(10) Pub. No.: US 2007/0075599 A1
(43) Pub. Date: Apr. 5, 2007

(54) Optically commutated self-rotating drive mechanism

(76) Inventor: William W. French, Cardiff-by-the-Sea, CA (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 10/575,972

(22) PCT Filed: Oct. 15, 2004
(86) PCT No.: PCT/US04/33891

§ 371 Date: Apr. 14, 2006

Related U.S. Application Data
(60) Provisional application No. 60/511,413, filed on Oct. 15, 2003.

(51) Int. Cl. H02K 11/00; H02K 23/04; H02P 7/06; H02P 1/04

(52) U.S. Cl. 310/68 B; 318/254; 318/480; 310/154.05

(57) ABSTRACT

A self-rotating enclosure (6) containing an electric motor (4) particularly suited for use in very low power and low speed applications, including a counter-torque producing magnet (34). The motor comprises magnets (M3,M4) which generate magnetic fields to interact with currents in coils of wire (C2,C3) to generate relative rotational motion between an armature assembly (2) and the motor case (4). A shutter (36) with a window (W1) controls light incident on photoresistor (P1) to energize a coil, (C2), and similarly other photoresistors control other coils to cooperatively generate relative rotation. The preferred embodiment uses photovoltaic cells (30) to provide the electric current.

### FIELD OF THE INVENTION

This invention relates to electric motors, and in particular, to motors that must operate for very long periods of time at low speed and low power levels.

### BACKGROUND OF THE INVENTION

The motors that power self-rotating objects as described in International Publication Number WO 2004/021369 A2 are designed to operate at very low speeds and very low power levels. Such motors preferably use coils of wire with many more turns and higher resistance values than most common motors, so that the impedance of the motor coils will more closely match the high impedance of the dimly illuminated photovoltaic cells, and thereby promote more efficient transfer of power from the photovoltaic cells to the motor. On the other hand, it is difficult and expensive to wind coils with very many turns of very fine wire, so it is preferable to keep the number of turns and coil resistance low. Thus, it is best to power such motors with one photovoltaic cell, or with a number of cells connected in parallel to minimize the internal resistance of the photovoltaic power source. Preferably the coil resistance is then made to match the impedance of the photovoltaic power source at a desired minimum light level for operation. If such a coil would have too many turns to be made economically, then the coil can be made with as many turns can be done for a reasonable cost, and thereby achieve a better impedance match between the photovoltaic source and the coil than could be achieved if the photovoltaic cells were connected in series, given some fixed overall cell area.

It is further desirable to cover as much of the area within these light powered objects as possible with photovoltaic cells, to minimize cell internal impedance at low light levels.

Brushes and commutator rings are commonly used to transfer electrical power from an external source to motor armatures and to commutate motors. The motors described here cannot tolerate high drag levels of brushes and cannot tolerate the occasional breaks in the conduction path that can occur in brush motors whenever some contaminant is positioned between the brush and the commutator ring.

Various means, other that commutator rings, are well known to commutate electric motors, but these generally employ various electronic components that add cost and complexity to a motor design. Furthermore, these electronic components require energy to operate and cannot be operated by a voltage as low as can be generated by one Amorphous silicon photovoltaic cell. Most of these existing motors need to operate in the dark, so optical commutation is not practical, unless internal sources of light are used.

The objects described in International Publication Number WO 2004/021369 A2 are preferably designed to operate at a speed which is reasonably constant over a wide range of lighting from direct sunlight to typical room light. This is accomplished by designing the motor so that the back electro-motive force (emf) generated at the maximum design speed is about equal to the maximum voltage of the source of emf powering the motor. Amorphous silicon photovoltaic cells typically generate about 0.8 volts (V), so a motor designed to operate at a maximum speed of 2 revolutions per minute (rpm) would need to generate a back electromotive force of about 0.8 V at 2 rpm. This same motor could be designed to operate at 2 rpm when driven by two amorphous silicon photovoltaic cells in series and delivering about 1.6 V, but the coils in the motor would now need to have twice as many turns, with finer wire.

In Nakamats, U.S. Pat. No. 5,731,676 there is described a motor that is commutated by controlling the light incident on a photovoltaic cell that is in series with one or more other photovoltaic cells which are continuously exposed to light. In this arrangement it is advantageous to have all the cells the same size, because the smallest cell will limit the overall current in the series. This kind of arrangement intrinsically has at least two solar cells connected in series, which doubles the voltage supplied to the coils. Thus, all things being equal, a motor made as taught in Nakamats, U.S. Pat. No. 5,731,676 will need twice as many turns on each coil as one which could be driven by one solar cell, or a number of such cells connected in parallel. If more cells are connected in series, all similarly controlled by light exposure to one of the cells, the overall usage of available area to continuously expose cells to light becomes even greater, but the voltage goes even higher.

It would also be possible to design a light commutated motor such as taught in Nakamats, U.S. Pat. No. 4.634,343 where each coil is driven by only one solar cell at a time. The drawback here is that only a small percentage of the overall area of solar cells is actually exposed to light at any given time, so the overall efficiency is low.

Photoresistors, also known as photocells, such as those made from CdS, are simply resistors with a resistance value that varies inversely with the illumination level falling on the cell. Their resistance can vary from a few ohms in full sunlight to megohms in absolute darkness. Such cells can be very small and they will pass current subject to Ohm's law.

The instant invention proposes to power the drive mechanism using a predetermined optimum supply voltage and to switch the current delivered to the motor coils by means of photocells. These photocells are typically very small so they will not detract from the area that can be covered with photovoltaic cells that are continuously exposed to light and that supply the current. This arrangement allows the designer to avoid the need for making coils have more turns, for a given motor design and maximum speed, than would be needed with the teaching of Nakamats, U.S. Pat. No. 5,731,676.

It is further advantageous for the objects described in International Publication Number WO 2004/021369 A2 to be able to continue to operate even as light drops to very low levels. The current that a photovoltaic cell can deliver typically drops approximately linearly with light level. Thus at very low light levels, for example at 5 lux, two amorphous silicon photovoltaic cells 95×45 mm connected in parallel can deliver about 26 micro amps to an 8,000 load. If a photocell such as #9001 made by Selco Company of Anaheim, Calif. is placed in series with these components to control the current, and this photocell has a resistance of about 16,000 Ohms at 5 lux, than it might be expected, by Ohms Law, that the current would be reduced to 26/3=8.6 micro amps. The new and unexpected result is that the current is actually 18 micro amps, because the photovoltaic cell is current limited at this very low level of illumination. Further reduction in light to 3 lux results in 14 micro amps without the photocell, and 12 micro amps with the photocell in the circuit. This difference in current of 2 micro amps corresponds to a power loss of 0.03 microwatts, which is far below the power required by the various electronic commutation circuits of the prior art. When the illumination on the cell drops by a big factor, such as 100, when the cell is shaded by the shutter, then the resistance of the photocell increases to very high levels and the current is effectively reduced to zero, so the motor can be effectively commutated.

In the commutation scheme proposed in U.S. Pat. No. 5,731,676 the photovoltaic cells that control the commutation would need to be shaded for a big percentage of the time the motor operates, and the power lost when they are shaded would also result in a loss of total available power delivered to the coils of far more than the 0.03 microwatts of the instant invention.

Jewel bearings can operate with very little friction and tolerate loads up to some limit, depending on the materials and size of the mating parts. To eliminate the need to transfer power to the armature by means of slip rings and brushes, it is preferable to mount the photovoltaic cells on the armature of the motor. The mass of these cells, together with the other parts on the armature, add up to a level of mass that can approach the limit that a jewel bearing of reasonable size and cost can tolerate.

### SUMMARY OF THE INVENTION

The principal and secondary objects of the invention are:

To provide a motor that does not need brushes or commutator rings to transfer power to the armature or to commutate the motor.

To power the motor with a large area photovoltaic cell having a good impedance match to the motor coils at minimum cost for the motor coils.

To optically commutate the motor with optical switching elements that take very little area away from the area available for the power generating photovoltaic cells.

To optically commutate the motor with optical switching elements that minimize the extra resistance to the flow of current to a motor coil.

To achieve optical commutation with a minimum number of electronic parts, at minimum cost, and maximum reliability.

To provide a magnet on the armature that will generate lifting forces to reduce the load on the jewel bearing.

To use the photovoltaic cells to help form a light baffle to control the amount of light reaching photocells that are supposed to be shaded in the commutation sequence.

### BRIEF DESCRIPTION OF THE DRAWINGS

FIG. 1 is a side sectional view of the preferred embodiment motor.

FIG. 2 is a top view of the preferred embodiment motor, with some parts removed.

FIG. 3 is a top view of the top iron disk part of the motor

FIG. 4 is a top view of the photocell disk motor part

FIG. 5 is a top view of the shutter motor part

FIG. 6 is a top view of the fully assembled motor

FIG. 7 is an electrical schematic diagram of the preferred embodiment.

FIG. 8a is a top, transparent view of the motor to illustrate the commutation sequence

FIG. 8b is a top, transparent view of the motor to illustrate the commutation sequence

FIG. 8c is a top, transparent view of the motor to illustrate the commutation sequence

FIG. 9a is an alternate electrical schematic diagram.

FIG. 9b is an alternate electrical schematic diagram.

FIG. 10 is an alternate shutter design.

FIG. 11 is an alternate circuit design that allows current to be applied to a coil in one polarity of the opposite polarity

FIG. 12 is a top view of a shutter-photocell arrangement that can be used with the circuit of FIG. 11.

### DESCRIPTION OF THE PREFERRED EMBODIMENT

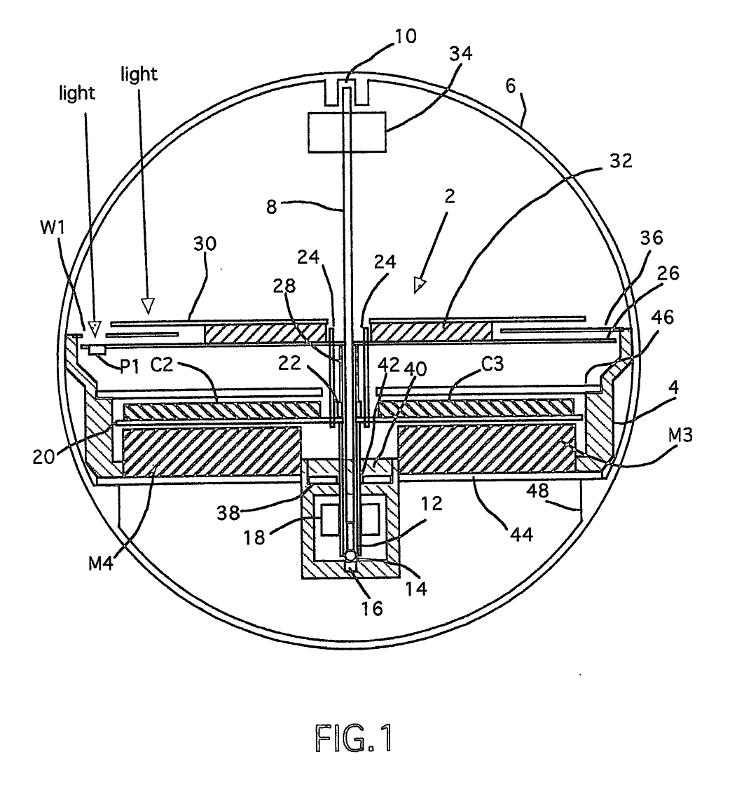

The preferred embodiment shown in FIG. 1 is similar in many ways to the quadrapole motor described in International Publication Number WO 2004/021369 A2. An armature assembly 2 is supported for rotation about a vertical axis within a motor case 4 contained in a translucent spherical outer shell 6. The armature assembly 2 comprises a shaft 8 loosely constrained at the top end by a cylindrical cavity 10 that can be a molded part of the outer shell 6. The lower end of the shaft 8 fits snugly into a shaft tube 12, which has a lower end that has been crimped to a diameter slightly smaller then the other inside diameter of the tube, so that a ball 12 can move without significant friction within the shaft tube 12, but so that the ball cannot move past the crimped end. A spring 13 is interposed between the bottom end of the shaft 4 and the ball 14, and is compressed so as to tend to force the ball out of the tube. The ball 14 rests in a sapphire cup 16 of a slightly larger radius than the ball, so the ball can rotate within the cup and thereby support the shaft 8 for rotation. A shaft tube magnet 18 is in the shape of a disk with a hole in the center is fixedly attached to the shaft tube 12.

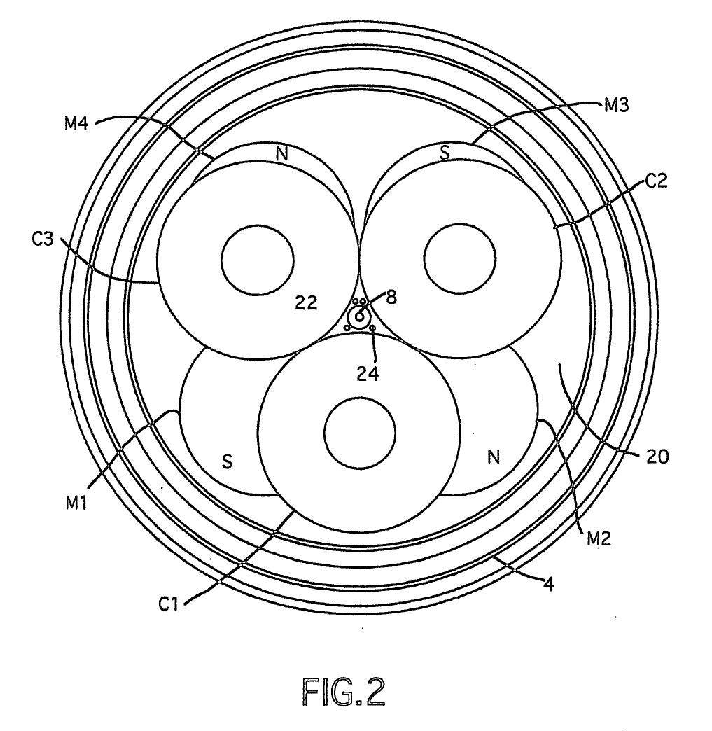

An armature disk 20 is fixedly attached to the shaft 8 my means of a bushing 22 which can be bonded to the armature disk 20 or soldered to it in the case where the armature disk is a printed circuit board (PCB). The bushing 22 can then be fixedly attached to the shaft 8 by bonding, thereby fixedly attaching the armature disk 20 to the shaft 4. Three coils of electrically conductive wire, C1, C2 and C3, shown more clearly in FIG. 2, are fixedly attached to the armature disk 20. Four conductive pins 24 are fixedly attached to the armature disk and electrical connections are made between the pins and the coils C1, C2, and C3, for example, by traces on the armature disk 20 if it is a PCB. One of the pins 24 will be a common connection to all three coils, and each of the three remaining pins will be connected to a different coil lead. Thus, a source of electrical current, photovoltaic cells 30, will have one lead connected to the common pin 24 and the other,a current input lead sequentially connected to each of the other three pins 24 to sequentially apply current to each of the coils, C1, C2, and C3.

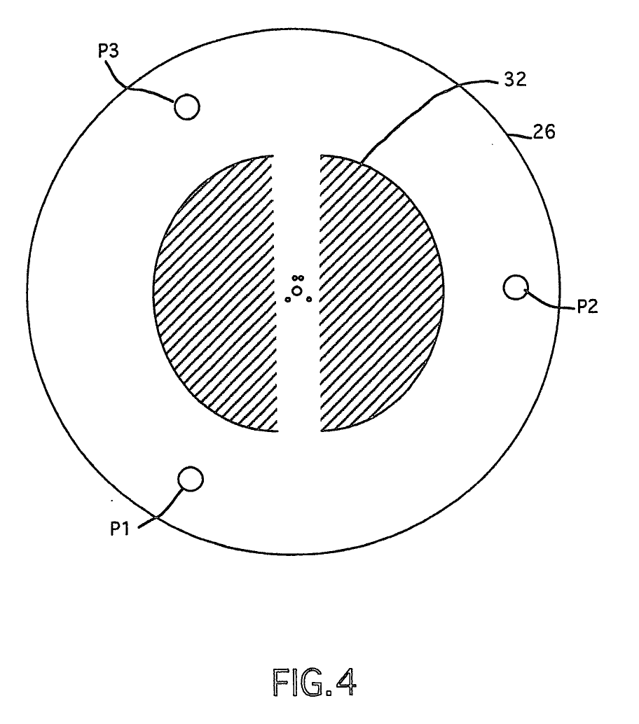

A photocell carrying disk 26 is fixedly attached to the armature disk 20, preferably by soldering the pins 24 to PCB traces on the photocell disk. A spacer tube 28 fitting over the shaft 8 sets the spacing between the photocell disk 26 and the armature disk 20, and will also provide additional mechanical support against shock loads. Three photoresistors or photocells, P1, P2 and P3 are mounted on the photocell disk in such a way that light coming from above will reach the photosensitive side of the photocells. FIG. 1 shows how the photocell, P1 for example, is mounted to receive light, but FIG. 4 shows in top view how the three photocells P1, P2, and P3 are mounted with respect to each other.

FIG. 1 shows photovoltaic cells 30 mounted on the photocell disk 26 by means of mounting blocks 32, which are preferably made of lightweight material, such as foam, with a contact adhesive on each side. These mounting blocks 32 are more clearly seen in top view in FIG. 4.

A cylindrical magnet 34 is fixedly attached to the shaft 8 to allow the motor to derive counter torque from ambient magnetic fields, as described in earlier applications, such as in the International Publications corresponding to International Patent Application Numbers PCT/US00/26394 and PCT/US00/28038. A shutter 36 with a window W1 is positioned between the photocell disk 26 and the photovoltaic cells 30. Window W1 in the photocell disk 26 is shown passing light through the shutter 36 to illuminate photocell P1. Light is also illuminating photovoltaic cells 30. The shutter 36 is fixedly attached to the motor case 4 around the periphery of the shutter in a way that prevents light from leaking past the ring shaped area where the shutter rests on the motor case. This can be accomplished by bonding the shutter 36 to the motor case 4 with opaque glue, or by making this a tight fit, as is well understood by those practiced in the art of making cameras, for example.

The motor case has mounted with it a bottom iron disk 42, a top iron disk 46, and field magnets M1,M2,M3, and M4 all essentially the same as described in the International Publication corresponding to International Patent Application Number PCT/US03/27234. The bottom iron disk 44 is resting on a support ring 48 comprising part of the inside surface of the outer shell 6. The motor case 4 also includes a small iron disk 38 which is fixed within a cavity 40 in the motor case. A hole 42 on the center of the small iron disk 38 allows the shaft tube 12 to pass through the small iron disk without touching it.

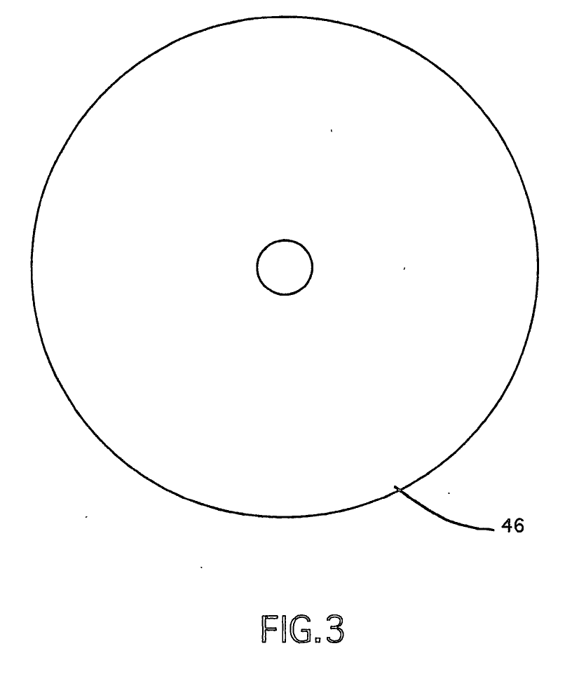

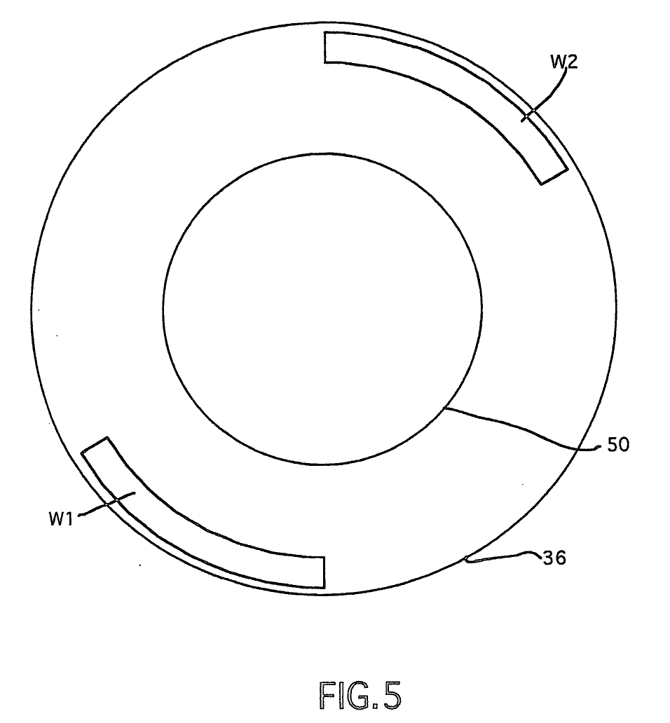

FIG. 2 shows a top view of the motor without the cylindrical magnet 34, photovoltaic cells 30, shutter 36, photocell disk 26, or top iron disk 46. Coils C1, C2, and C3 are seen mounted on armature disk 20, for rotation above the 4 field magnets, M1,M2,M3, and M4. The 4 pins 24 are shown arrayed around the shaft 8 and the bushing 22. FIG. 3 shows a top view of the top iron disk. FIG. 4 shows a top view of the photocell disk 30 including the three photocells, P1, P2, and P3, and the two mounting blocks 32. FIG. 5 shows a top view of the shutter 36 including windows W1 and W2 and a central hole, 50.

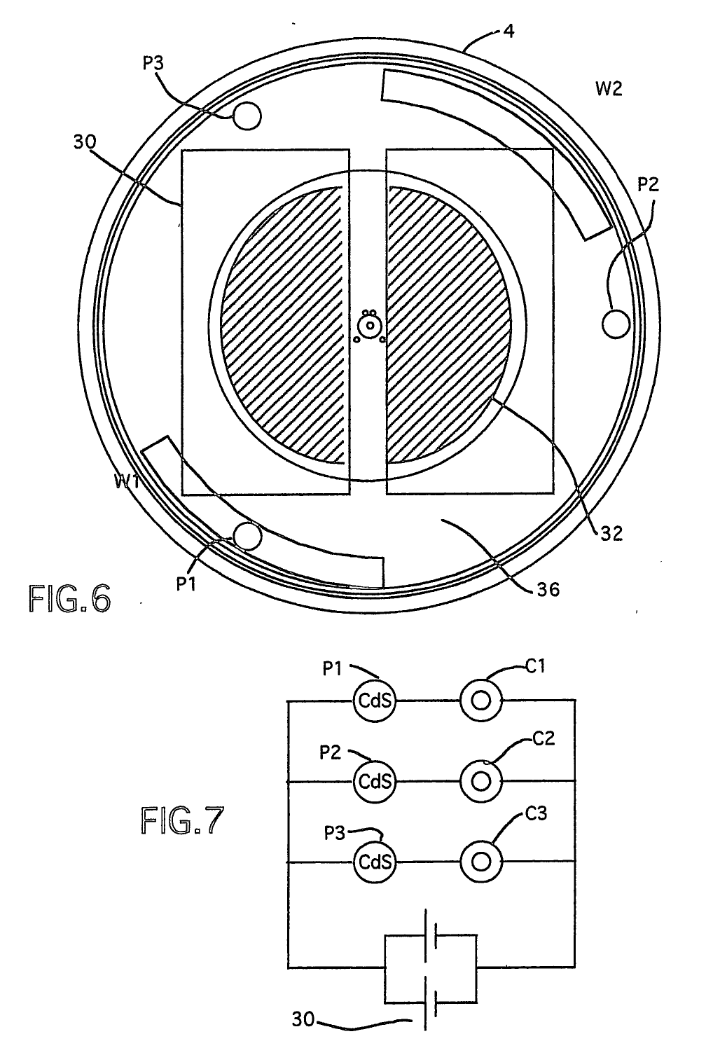

FIG. 6 shows a top view of the motor without the cylindrical magnet 34, and with the photovoltaic cells 30 shown as transparent to clearly show the parts behind them, including the mounting blocks 32, the photocell disk 26, the shutter 36, with windows W1 and W2.

FIG. 7 shows a schematic diagram of the motor circuit including the photovoltaic cells 30, photocells P1, P2, and P3, and the coils C1, C2, and C3. The exact layout of circuit traces on the armature disk 20 and on the photocell disk 26 has not been shown for simplicity, and because this kind of connecting is well understood by those skilled in the art.

The jewel bearing assembly 17 comprising the shaft tube 12, the shaft 4, the ball 14, the spring 13, and the sapphire cup 16, functions to support the armature assembly 2 for rotation with very low friction, while protecting the ball 14 and the sapphire cup 16 from excess loads in the case when the motor might receive significant mechanical shocks. Motors have been made, for example, using tungsten carbide balls 14 with a diameter of 0.078 inches, in a sapphire cup 16 with a cup diameter of 0.093 inches, and with a spring 13 applying a force of 150 g to the ball. The weight of the entire armature assembly was about 150 g, so the magnetic attraction between the shaft tube magnet 18 and the small iron disk 38 and also the bottom iron disk 44 was needed to reduce the operating load on the sapphire cup 16 to about 100 g.

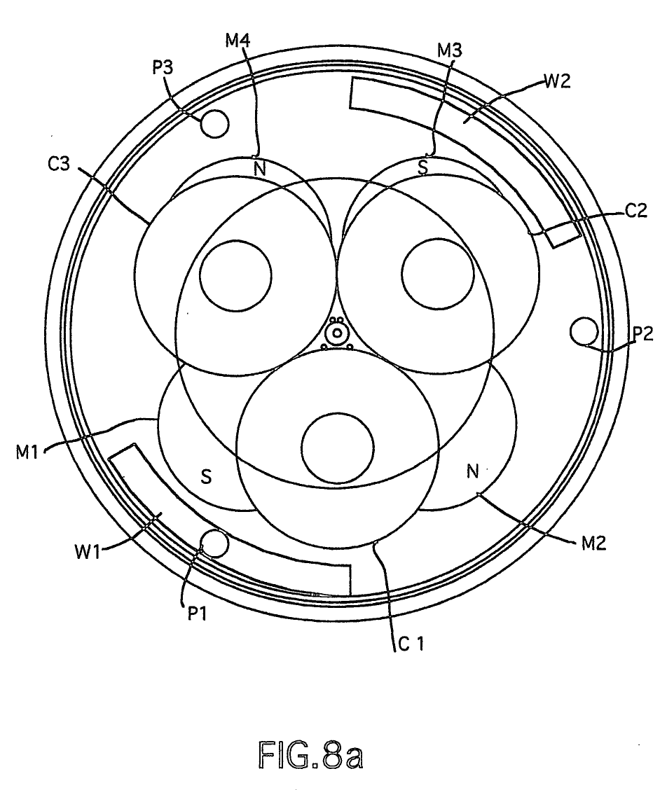

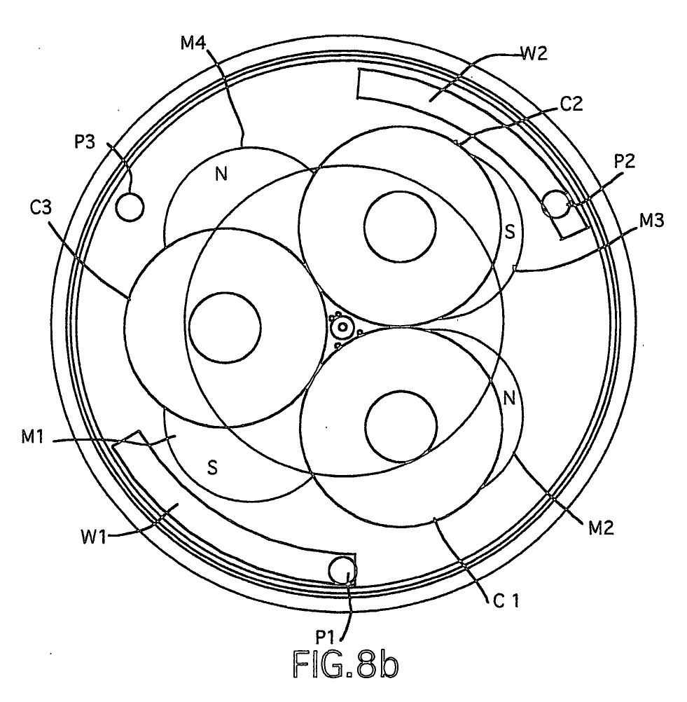

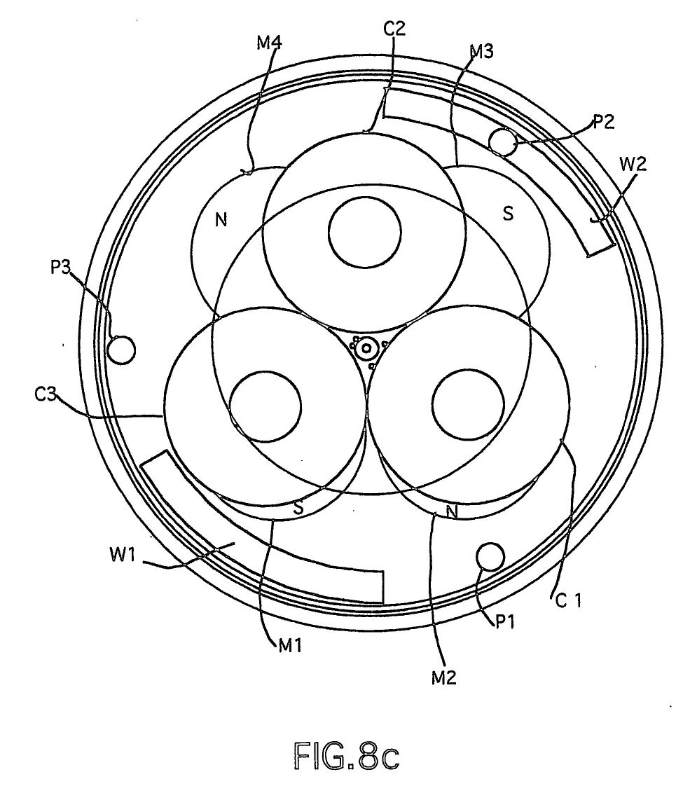

FIGS. 8a, 8b, and 8c illustrate a commutation sequence for the motor, which is very similar to that described in the International Publication corresponding to International Patent Application Number PCT/US03/27234, but now commutation is achieved by means of the interactions of the photoresistors P1, P2, and P3 with the ambient light as controlled by the shutter 36. A starting position is shown in FIG. 8a where photocell P1 is illuminated, energizing coil C1, and photocells P2 and P3 are shaded, causing their resistance to be high and preventing any significant current from flowing in coils C2 and C3. Coil C2 is positioned half way between magnets M1 and M2, and the connections between the photovoltaic cells 30 and coil C1 is such that current flowing in coil C1 will urge the movable armature assembly 2 to rotate in a counter-clockwise direction. In this way, the cooperation of the these structures acts a commutator for the motor by alternately energizing and de-energizing the appropriately located coils according to their relative position with the corresponding magnets.

Given that the armature assembly 2 is free to rotate, the force generated by coil C1 will cause the armature assembly to eventually reach the orientation shown in FIG. 8b. Here both photocells P1 and P2 are illuminated, by light through windows W1 and W2, respectively, and the angular positions of both coil C1 and could C2 are still such that they will tend to create counterclockwise rotation. Photocell P3 is well shaded, so will it not receive significant current.

Continued counterclockwise rotation will cause the armature assembly 2 to reach the orientation shown in FIG. 8c, where is coil C2 is now generating essentially the same torque as coil C1 was generating in FIG. 8a.

While this description of the motor operation is given in terms of the armature rotating, it is clear that the same commutation sequence applies to the situation more common in the objects the motor will be used in, where the armature is held from rotating by magnetic forces on the cylindrical magnet 34, while the motor case 4 rotates.

The torque that is generated by coils driven by photocells that are shaded should preferably be kept to a minimum. For example, in FIG. 8b, coil C3 is centered on a magnetic transition between magnets M1 and M4 of opposite polarity from the transitions between magnets M1 and M2 and between magnets M3 and M4. For this reason, if a significant current is allowed to flow in coil C3 in the position shown in FIG. 8b, it will create a significant force in the direction opposite to the desired rotation of the armature assembly 2, and this will inhibit the rotation.

Various elements of the design work together to insure adequate shading of the cells that need to be shaded. The photocells 30 are mounted in a position to optimize their exposure to light in order to generate current effectively, but also to block light from reaching the position of the photocells, P1, P2, and P3, except when the light is passing through windows W1 and W2. The mounting blocks 32 also block light, and the narrow spacing between the shutter 36 and the photocell disk 26 keeps stray light away from shaded photocells. The surfaces of shutter 36, and the top surface of the photocell disk 26 were all made black colored to reduce light reflections. The effectiveness of this light baffle structure could be improved even more, for example, by using a disk shaped photovoltaic cell with a diameter just less than the photocell mounting pattern or my mounting the rectangular cells 30 on a disk of an opaque material.

A prototype motor was made inside a ball with an outside diameter of 6 inches. All of the parts were made essentially to scale, as shown in FIG. 1 through FIG. 8. The spacing between the shutter 36 and the photocell disk 26 was 2 mm and the spacing between the shutter 36 and the photovoltaic cells 30 was 2 mm. The coils C1, C2, and C3 had 8000 Ohms resistance each, and had about 8000 turns, and the photocells, P1, P2, and P3 were type 9001 made by Selco Company of Anaheim, Calif., The photovoltaic cells were 95×45 mm amorphous cells that will, when connected in parallel, generate 0.35 V across 8000 Ohms with 10 lux illumination. This prototype operates at about 2 RPM in direct sunlight, and will continue to rotate at lower speed down to 3 lux.

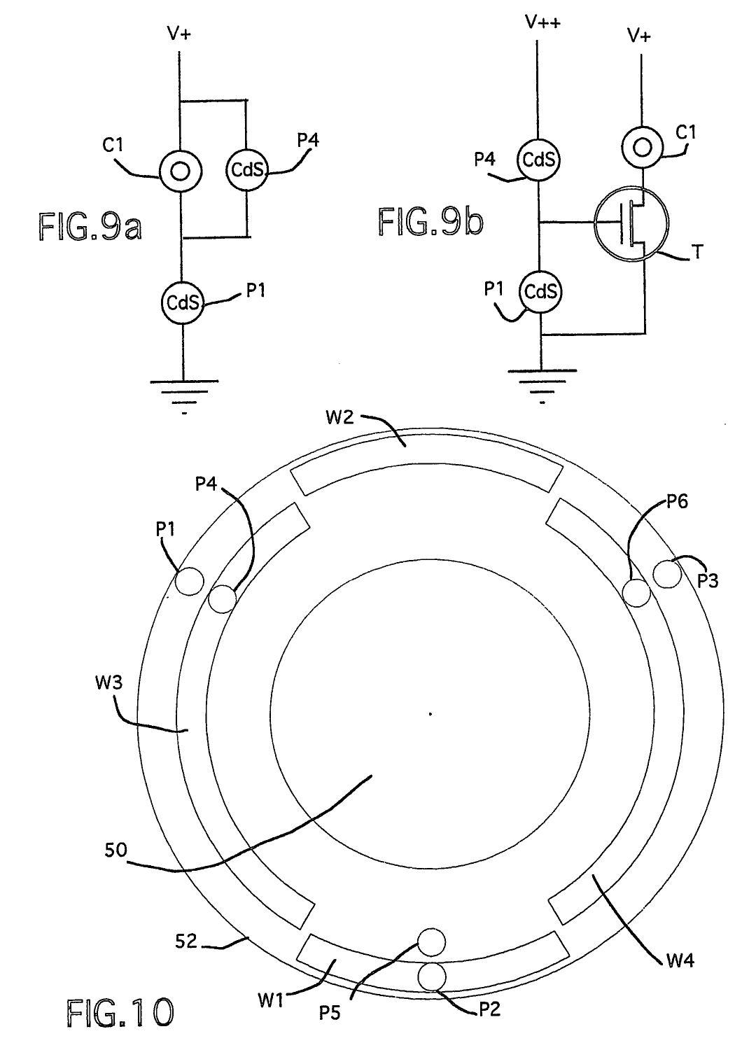

FIG. 9a shows an alternate embodiment where an additional photocell, P4, can be added so that it is wired across the coil to help further insure that no significant current will flow in the coil C1, for example, when photocell P1 is shaded. It is intended that photocells P1 and P4 be mounted on a 6 photocell disk 50 as shown in FIG. 10, and be shaded by a four window shutter 52, with windows W1, W2, W3, and W4. In the orientation shown in FIG. 10, photocell P1 would be shaded to block current from coil C1 and photocell P4 would be illuminated to shunt any residual current that might reach coil C1. Photocells P2 and P5 will also cooperate to deliver current to coil C2, and photocells P3 and P6 will co-operate to block current in coil C3. Whenever any coil in not supposed to receive current, it will be shunted by a photocell that is illuminated, and whenever any coil is supposed to receive current, the photocell shunting it will be shaded and not shunt a significant current away from that coil. The commutation of this motor then proceeds as the armature rotates, as described above when only P1, P2, and P3 were used.

It would also be possible to make this switching to insert less resistance in the current path and to block current more completely in coils that are not supposed to receive current by using a circuit such as shown in FIG. 9b. In this case the voltage at the junction of photocells P1 and P4 is sensed by a MOSFET T and current to the coil C1 is either completely turned on or completely turned off. The MOSFETs need some minimum voltage to operate of at least about 2.5 V, which is more than a single photovoltaic cell can deliver. FIG. 9 shows two voltage sources could be used to supply voltage V+ to the coil C1, and a separate, higher voltage supply, V++, could be used to drive the MOSFETS T. It could clearly be possible to use the same V++ source to drive both the MOSFETS and the coil C1, but this would not be as effective at delivering current to the coil, give the resistance value that is practical for such a coil.

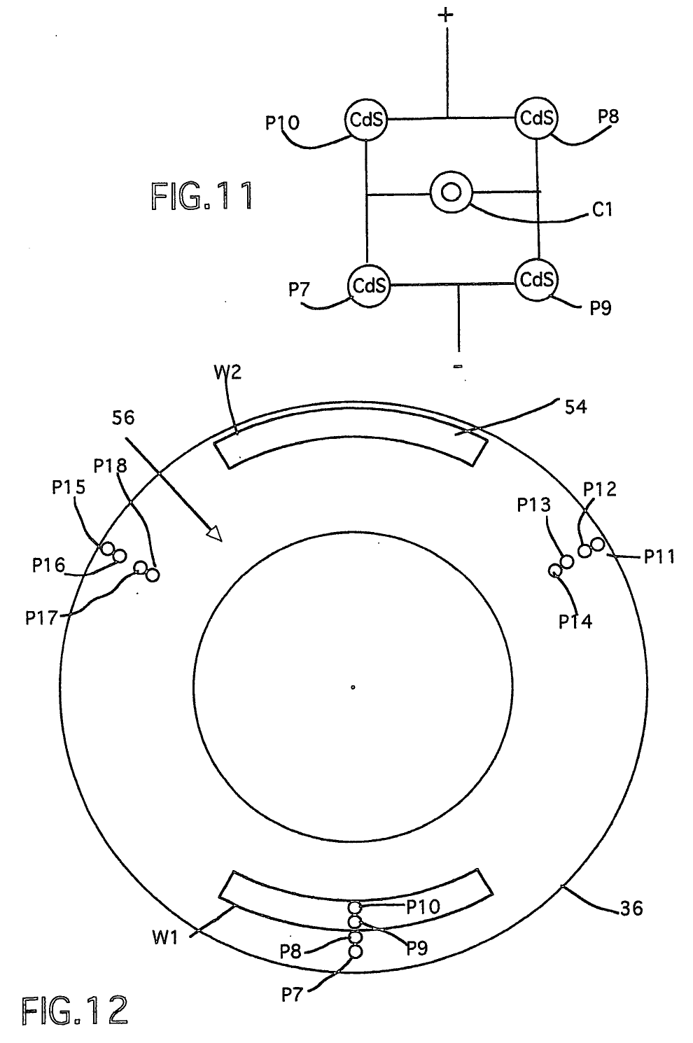

Many electric motors use a 3-segment slip ring, two brushes, a magnet with two poles, and three coils on the armature. For example see the motor of PCT/US03/27234. These motors switch the current to coils every 60 of rotation, and the current reverses polarity in each coil, depending on the polarity of the magnetic transition that the coil is near when it is activated. Such a motor can be commutated optically using the electrical circuit shown in FIG. 11 and the shutter-photocell arrangement shown in FIG. 12. Shutter 36 in FIG. 12 is shown as transparent so the position of all of the photocells can be seen as they are mounted on the 12 photocell disk 54.

FIG. 11 shows an alternate approach in which a coil 1 in a bridge circuit with photocells P7, P8, P9, and P10. FIG. 12 shows these same photocells interacting with the shutter 36 and window W1. It as assumed that coil C1 is positioned over the center of a magnetic transition, so the photocells P7, P8, P9, and P10 need to be illuminated so as to apply current of a predetermined polarity to coil C1. Photocells P7 and P8 are illuminated and photocells P9 and P10 are shaded. The circuit of FIG. 11 makes it clear that current will flow through coil C1 with a polarity we will call left to right. This polarity is predetermined to urge the armature in the desired direction. When the armature has rotated through 180° then the illumination and shading of photocells P7, P8, P9, and P10 will be reversed, and current will flow through coil #1 with the opposite polarity, but since the magnetic transition is now reversed, the rotation of the armature will continue to be in the same direction. There will be three bridge circuits as are shown in FIG. 11, and all will be powered by a connection to the photovoltaic cells, such as 30. Photocells P11, P12, P13, P14, P15, P16, P17 and P18 are shaded so they will pass very little current, particularly through coils C2 and C3 until the 12 cell armature assembly 56 rotates to position them near a window.

As photocells P7, P8, P9, and P10 rotate away from window W1, owing to the counter clockwise rotation of the 12 photocell disk 54 that they are mounted on, photocells P11, P12, P13 and P14 will move to the vicinity of window W2 and activate coil #2 for 60° of continued armature rotation, at which point photocells P 15, P16, P17, and P18 will reach the vicinity of window #1 and energize coil #3 which will urge continued counterclockwise rotation.

While it is sometimes advantageous to use ambient light to illuminate both the photovoltaic cells and the photocells, it is clear that it would be possible to alternately illuminate the photocells with light sources within the motor, such as LEDs. These could be powered by current derived from the solar cells or from current derived from an internal chemical cell. This method of illuminating the photocells would allow the motor to be deep inside an object where little ambient light is present. It would also be possible to conduct ambient light to photocells remote from ambient light sources by means of optic light guides of various well known designs.

Although permanent magnets are preferred, it is possible to non-permanent magnets such as electromagnets.

The light baffle is needed to prevent too much light from reaching cells that are not supposed to be illuminated. Other kinds of baffles can achieve the same effect, as will be known to those skilled in the art. There are some optical materials, commonly used for coatings on eyeglasses, which become much less transparent when exposed to bright light. A transparent film coated with such a material and covering the photocells would be transparent at low light, and would become much less transparent at bright light, helping to reduce the tendency of shaded cells to conduct.

While prototypes have been made with CdS photocells, it is clear that other types of photocells with similar electrical characteristics could be used in place of the CdS type.

1. An electrical motor which comprises:
a current input lead;
a first conductive coil;
a first magnet; and
a commutator for alternately energizing said first coil according to a relative position between said first coil and said magnet, wherein said commutator comprises a first optical switching element wired in series between said lead and said first coil.

2. The motor of claim 1 which further comprises a movable armature for allowing a change in relative position between said first coil and said magnet.

3. The motor of claim 2, wherein said device further comprises a light shutter for alternately exposing said first optical switching element to a light source in association with a position of said armature.

4. The motor of claim 3, wherein said light source is an ambient light source.

5. The motor of claim 1, wherein said magnet is a permanent magnet.

6. The motor of claim 1, which further comprises:
a second conductive coil; and,
said commutator further comprises a second optical switching element wired in series between said lead and said second coil.

7. The motor of claim 6, which further comprises:
a third conductive coil; and,
said commutator further comprises a third optical switching element wired in series between said lead and said third coil.

8. The motor of claim 1, wherein said first optical switching element is further wired through a voltage divider.

9. The motor of claim 3, which further comprises a first shunting photoresistor wired to said first coil to reduce the current in said first coil while said first optical switching element is shaded by said shutter, and said first shunting photoresistor is illuminated by said shutter.

10. A motorized device which comprises:
a current source; and,
an electrical motor for driving said device, wherein said motor comprises:
a first conductive coil;
a first magnet; and
a commutator for alternately energizing said first coil, wherein said commutator comprises said first optical switching element being wired in series between said current source and said first coil.

11. The device of claim 10, which further comprises a movable armature for allowing a change in relative position between said first coil and said first magnet.

12. The device of claim 11, which further comprises a light shutter for alternately exposing said first optical switching element to a light source depending on the position of said armature.

13. The device of claim 12, wherein said current source comprises a photovoltaic cell.

14. The device of claim 13, wherein said light source powers said cell.

15. A commutator for an electric motor having a current lead, at least one conductive coil and at least one magnet, said commutator comprises:
a optical switching element wired in series between said lead and said coil; and,
means for alternately exposing and shading said optical switching element to a light source at specified relative positions between said coil and said magnet, thereby controlling the current through said coil.

16. The commutator of claim 15, wherein said means for alternately exposing and shading comprise a shutter assembly.

17. An electric motor which comprises:
a current input lead;
a first coil;
a first optical switching element connected in series between said coil and said lead; and
a shutter formed between said first optical switching element and a light source, whereby said first coil is energized when said shutter is open.
